(19) United States
(12) Patent Application Publication
(10) Pub. No.: US 2013/0026999 A1
(43) Pub. Date: Jan. 31, 2013

(54) BATTERY DEVICE

(71) Applicant: Kun-Ta LEE, New Taipei City (TW)

(72) Inventor: Kun-Ta LEE, New Taipei City (TW)

(21) Appl. No.: 13/490,938

(22) Filed: Jun. 7, 2012

(30) Foreign Application Priority Data
Jul. 29, 2011 (TW) 100214067

(51) Int. Cl. H02J 7/04

(52) U.S. Cl. 320/162

(57) ABSTRACT

A battery device including a case, an elastic component, a metal coil, a magnetic component, at least one energy storage component and a rectifier voltage regulator circuit is provided. The case includes a first and a second electrode ends, and both the elastic component and the metal coil are disposed in the case. The magnetic component is disposed in a receiving space of the coil and connects to an end of the elastic element, and the energy storage component connects to the first and the second electrode ends in parallel. When the battery device moves back and forth along a direction, the elastic component extends or retracts to drive the magnetic component to move back and forth relative to the metal coil along this direction. Thereby, an electric energy is induced in the metal coil, and is then stored in the energy storage component after being rectified and voltage-regulated.

This application claims the benefit from the priority to Taiwan Patent Application No. 100214067 filed on Jul. 29, 2011, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a device capable of generating electric power by itself, and more particularly, to a battery device capable of generating electric power through electromagnetic induction.

2. Descriptions of the Related Art

Batteries are widely used as main energy sources in various small-sized electronic products. For example, computer mice, TV set remote controllers, flashlights and so on are usually supplied by the commonly used #3 or #4 dry batteries. When the electrical power of the batteries runs out, the batteries can only be recycled as waste batteries. However, there are a lot of problems with the recycling of waste batteries. Specifically, the batteries contain metals such as zinc (Zn), manganese (Mn), nickel (Ni), Cobalt (Co) and iron (Fe), and in particular, heavy metals that are the most harmful to the environment such as lead (Pb), mercury (Hg) and Cadmium (Cd). Therefore, if the batteries are buried arbitrarily, the substances contained in the batteries will leak into the water source and soil, causing great harm to the ecological environment and peoples' health.

Therefore, the development of a battery device that can generate power consistently and can be used repeatedly will avoid subsequent harm to the environment and peoples' health. Accordingly, an urgent need exists in the art to provide a battery device that is less harmful to the environment and that can generate power to allow for repeated use.

### SUMMARY OF THE INVENTION

To solve the aforesaid problems, an objective of the present invention is to provide a battery device, which can generate power in a sustainable way and allow for repeated use to avoid harm to the environment. The battery device can generate power by itself through electromagnetic induction to supply electric power to a load.

To achieve the aforesaid objective, the present invention provides a battery device, which comprises a case, a first elastic component, a first metal coil, a first magnetic component, at least one electric power storage component and a rectifier voltage regulator circuit. The case has a first electrode end and a second electrode end opposite to the first electrode end. The first elastic component is disposed in the case, and extends or retracts along the first direction. The first metal coil is disposed in the case and defines a first receiving space. The first magnetic component is disposed in the first receiving space and connects to an end of the first elastic component. The at least one electric power storage component is disposed in the case, and is connected in parallel with the first electrode end and the second electrode end. The rectifier voltage regulator circuit is electrically connected between the first metal coil and the at least one electric power storage component. When the battery device moves along the first direction back and forth, the first elastic component extends or retracts to drive the first magnetic component to move back and forth along the first direction to make a relative displacement with respect to the first metal coil, and thereby, the first metal coil generates a first electrical energy, which is rectified and voltage-regulated by the rectifier voltage regulator circuit and then stored in the at least one electric power storage component.

To achieve the aforesaid objective, the present invention further provides a battery device, which comprises a case, a first cantilever, a first magnetic component, a first metal coil, at least one electric power storage component and a rectifier voltage regulator circuit. The case has a first electrode end and a second electrode end opposite the first electrode end. The first cantilever is disposed in the case. The first magnetic component is disposed at an end of the first cantilever. The first metal coil is disposed in the case and parallel to the first magnetic component. The electric power storage component is disposed in the case and connected in parallel with the first electrode end and the second electrode end. The rectifier voltage regulator circuit is electrically connected between the first metal coil and the electric power storage component. The first cantilever drives the first magnetic component disposed at the end to make a relative displacement with respect to the first metal coil when the battery device moves, and thereby, the first metal coil generates a first electrical energy, which is rectified and voltage-regulated by the rectifier voltage regulator circuit and then stored in the electric power storage component.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a battery device according to the first embodiment of the present invention;

FIG. 2 is a schematic view of the first elastic component of the battery device according to the first embodiment of the present invention in a pre-compressed status;

FIG. 3 is a schematic view of the first elastic component of the battery device according to the first embodiment of the present invention in a status in which the elastic energy thereof has been released;

FIG. 4 is a schematic view of other implementations of the battery device according to the first embodiment of the present invention;

FIG. 5 is a schematic view of a battery device according to the second embodiment of the present invention;

FIG. 6 is a schematic view of the battery device according to the second embodiment of the present invention when it is moving;

FIG. 7 is another schematic view of the battery device according to the second embodiment of the present invention when it is moving;

FIG. 8 is a schematic view of another implementation of the battery device according to the second embodiment of the present invention;

FIG. 9 is a schematic view of a battery device according to the third embodiment of the present invention;

FIG. 10 is a schematic view of the battery device according to the third embodiment of the present invention when it is moving;

FIG. 11 is another schematic view of the battery device according to the third embodiment of the present invention when it is moving;

FIG. 12 is a schematic view of another implementation of the battery device according to the third embodiment of the present invention;

FIG. 13 is a schematic view of a battery device according to the fourth embodiment of the present invention;

FIG. 14 is a schematic view of the battery device according to the fourth embodiment of the present invention when it is moving;

FIG. 15 is another schematic view of the battery device according to the fourth embodiment of the present invention when it is moving;

FIG. 16 is a schematic view of another implementation of the battery device according to the fourth embodiment of the present invention.

### DESCRIPTION OF THE PREFERRED EMBODIMENT

In the following description, the present invention will be explained with reference to embodiments thereof. However, the description of these embodiments is only for the purpose of illustrating the technical contents and effects of the present invention rather than to limit the present invention. It should be appreciated that in the following embodiments and attached drawings, elements unrelated to the present invention are omitted from depiction; and dimensional and positional relationships among individual elements in the attached drawings are illustrated only for the ease of understanding, but not to limit the actual scale and dimensions.

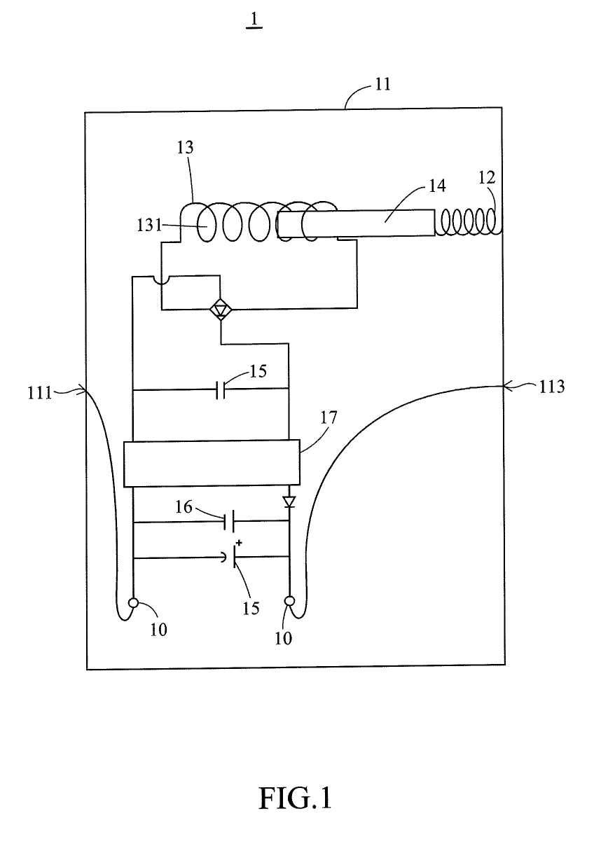

The first embodiment of the present invention is a battery device 1. FIG. 1 is a schematic view of the battery device 1 when it is not swung. The battery device 1 comprises a case 11, a first elastic component 12, a first metal coil 13, a first magnetic component 14, two electric power storage components 15, a charging capacitor 16 and a rectifier voltage regulator circuit 17.

The case 11 has a first electrode end 111 and a second electrode end 113 opposite to the first electrode end 111. The first elastic component 12 may be disposed in the case 11 and connected to an end of the case 11, and can extend or retract along a certain direction. The first metal coil 13 is disposed in the case 11 and defines a first receiving space 131, which is just an internal hollow portion of the first metal coil 13. The first magnetic component 14 is disposed in the first receiving space 131 and is connected to an end of the first elastic component 12 that is opposite to the end connected to the case 11; and furthermore, the first magnetic component 14 makes no contact with the first metal coil 131, so it can move in the first receiving space 131 without any obstruction. The two electric power storage components 15 and the charging capacitor 16 are disposed in the case 11 and, respectively, connected in parallel with the first electrode end 111 and the second electrode end 113. The rectifier voltage regulator circuit 17 is electrically connected between the first metal coil 13 and the two electric power storage components 15. It shall be appreciated that in this embodiment, the battery device 1 is of a size of an AA type battery, an AAA type battery, a C type battery or a D type battery; the first elastic component 12 may be a spring or an elastic piece; the first magnetic component 14 may be a magnet; the first metal coil may be made of copper; the two electric power storage components 15 are two capacitors, and the two electric power storage components 15 are two capacitors. The two capacitors are each made of gold with a small volume but a large capacity, and in other embodiments, there may also be only one or more than two capacitors. The rectifier voltage regulator circuit 17 is an LDO (Low Drop Out) voltage regulator or a Zener diode.

Hereinbelow, the operation mechanism of the battery device 1 of this embodiment will be described in detail.

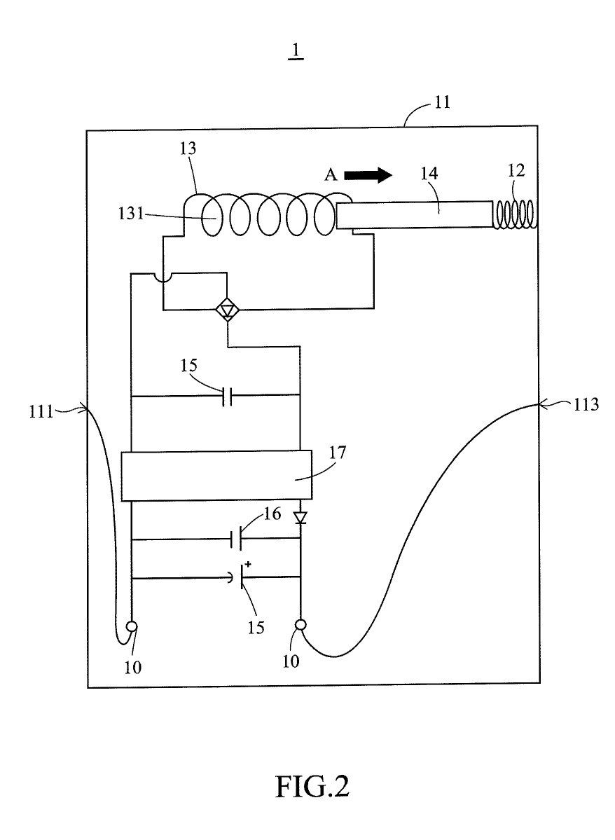

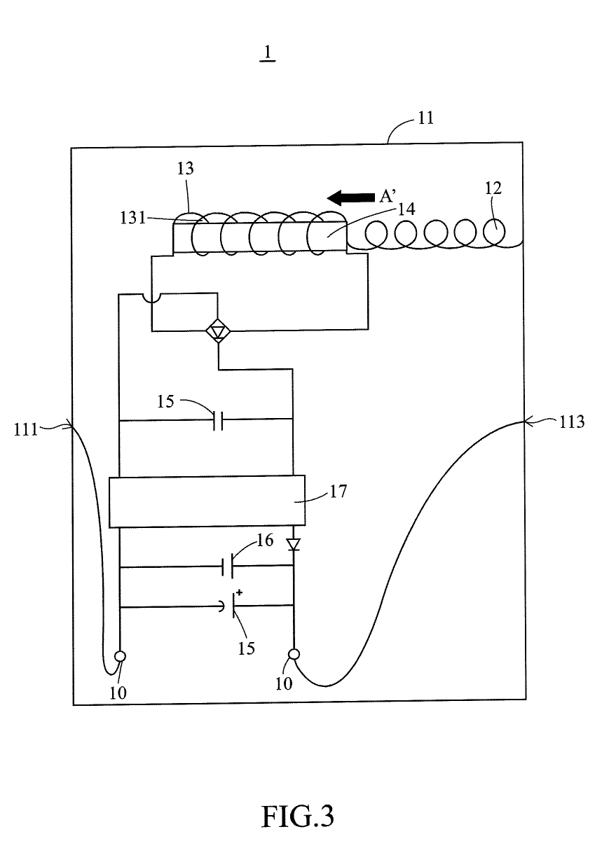

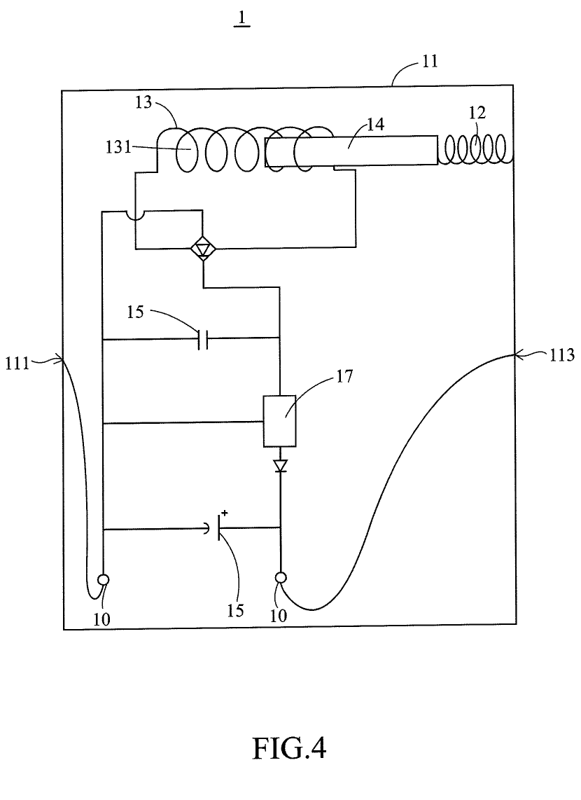

FIG. 2 illustrates a schematic view of the first elastic component 12 of the battery device 1 in a pre-compressed status. When the battery device 1 begins to move in a first direction A (as shown by the arrow) and the movement vector is greater than zero, the first elastic component 12 in the battery device 1 begins to move along the first direction A (as shown by the arrow) from an original status (i.e., a status in which the first elastic component is not compressed by an external force, as shown in FIG. 1). As a result, the first elastic component 12 is compressed by the first magnetic component 14 (as shown in FIG. 2), so that the first elastic component 12 has a tendency to restore its original status. FIG. 3 is a schematic view of the first elastic component 12 of the battery device 1 in a status in which the elastic energy thereof is released. Then, the first elastic component 12 provides a pushing force to the first magnetic component 14 in a direction opposite the compression direction so that the first magnetic component 14 is driven to move towards a direction A′ opposite the first direction A to stretch the first elastic component 12. Through the extension or retraction of the first elastic component 12, the first magnetic component 14 can be driven to move in the first direction A and the opposite direction A′ back and forth (as shown in FIG. 2 and FIG. 3). Because of the relative displacement between the first metal coil 13 and the first magnetic component 14, a first electric energy (not shown) is induced in the first metal coil 13. The first electric energy is rectified and the voltage-regulated by the rectifier voltage regulator circuit 17 and then stored in the two electric power storage components 15 and the charging capacitor 16. Then, by connecting two terminals 10 leading from the two electric power storage components 15 to the first electrode end 111 and the second electrode end 113 of the case 11 respectively, the battery device 1 can be installed in an electronic product to generate power. In other practical implementations, the operation sequence shown in FIG. 2 and FIG. 3 may be altered. Specifically, as shown in FIG. 3, when the battery device 1 begins to move so that the first elastic component 12 is stretched by the first magnetic component 14, the first elastic component 12 is stretched in the first direction A. Because the first elastic component 12 has a tendency of restoring its original status, a pulling force is provided by the first elastic component 12 to the first magnetic component 14 in a direction opposite the stretching direction. Therefore, the operation sequence can be altered by those of ordinary skill in the art, and no further description will be made herein. Other implementations may be devised by those skilled in the art upon reviewing the description of the first embodiment. As an example, the battery device 1 shown in FIG. 4 has substantially the same components as the first embodiment; that is, the battery device 1 shown in FIG. 4 also comprises a case 11, a first elastic component 12, a first metal coil 13, a first magnetic component 14, two electric power storage components 15 and a rectifier voltage regulator circuit 17. In other words, only the charging capacitor 16 of the first embodiment is omitted, and those of ordinary skill in the art can replace it with other components with similar functions; that is, the present invention is not limited to what has been described above.

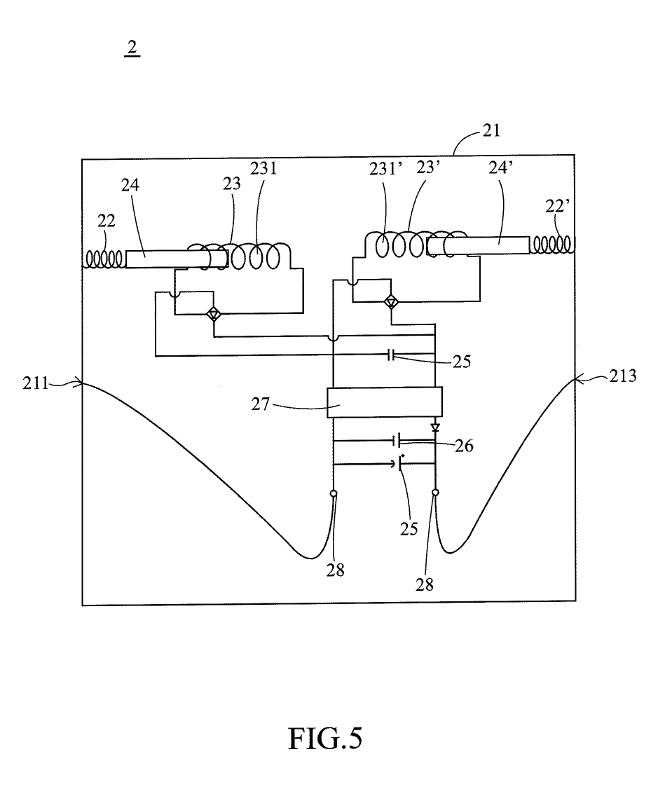

The second embodiment of the present invention is a battery device 2. FIG. 5 is a schematic view of the battery device 2 when it is not swung. The battery device 2 of this embodiment comprises a case 21, a first elastic component 22, a second elastic component 22′, a first metal coil 23, a second metal coil 23′, a first magnetic component 24, a second magnetic component 24′, two electric power storage components 25, a charging capacitor 26 and a rectifier voltage regulator circuit 27. The first metal coil 23 is disposed in the case 21 and is adapted to define a first receiving space 241. Therefore, the components of the second embodiment are substantially the same as those of the first embodiment except that a second elastic component 22′, a second metal coil 23′ and a second magnetic component 24′ are additionally provided in the battery device 2 of this embodiment. The second elastic component 22′ is disposed in the case 21 and extends or retracts synchronously with the first elastic component 22; the second metal coil 23′ is disposed in the case 21 and is adapted to define a second receiving space 251, which is just an internal hollow portion of the second metal coil 23′. The first metal coil 23 and the second metal coil 23′ are connected in parallel. The second magnetic component 24′ is disposed in the second receiving space 251 and connected to an end of the second elastic component 22′ opposite the end that is connected to the case 21. The second magnetic component 24′ makes no contact with the second metal coil 23′, so it can move in the second receiving space 251 without any obstruction.

Hereinbelow, the operation mechanism of the battery device 2 of this embodiment will be described in detail.

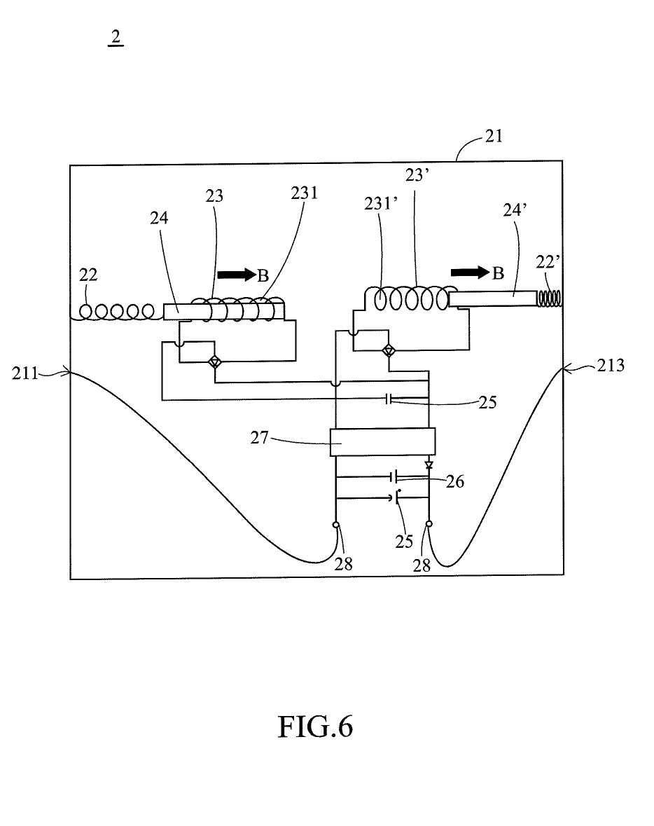

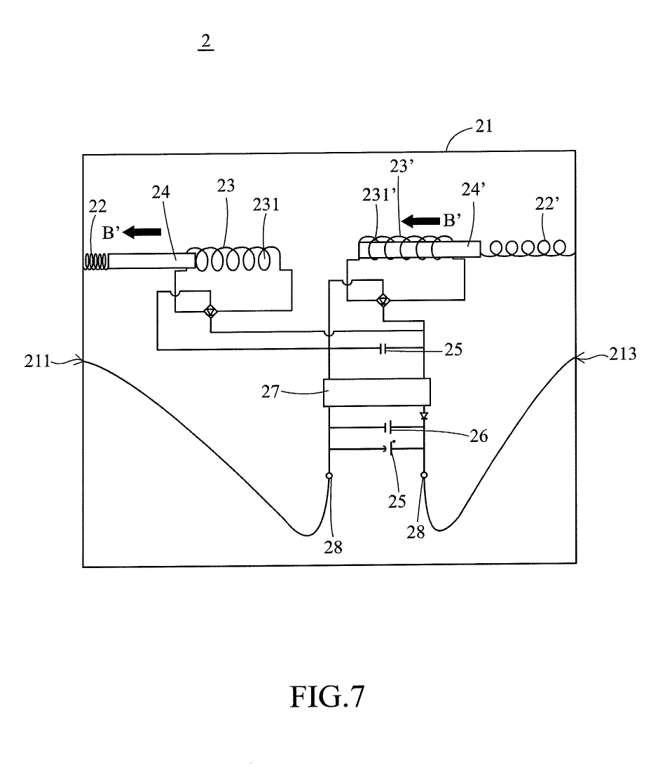

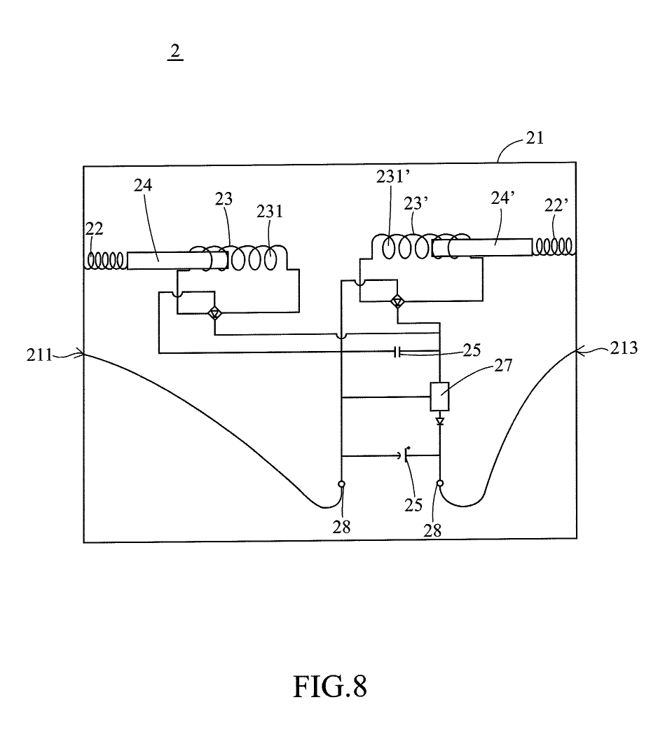

When the battery device 2 begins to move in a first direction B (as shown by the arrow) and the movement vector is greater than zero, the first elastic component 22 and the second elastic component 22′ in the battery device 2 begin to move along the first direction B from their respective original statuses (i.e., statuses in which the first elastic component 22 and the second elastic component 22′ are not compressed by an external force, as shown in FIG. 5). FIG. 6 is a schematic view of the first elastic component 22 and the second elastic component 22′ when being compressed by an external force respectively. Because the first elastic component 22 is stretched by the first magnetic component 24 and the second elastic component 22′ is compressed by the second magnetic component 24′ (as shown in FIG. 6), the first elastic component 12 is stretched and the second elastic component 22′ is compressed. The first elastic component 22 and the second elastic component 22′ have a tendency to restore their respective original statuses. FIG. 7 is a schematic view of the first elastic component 22 while the second elastic component 22′ of the battery device 2 in a status in which the elastic energy thereof is released. Then, the first elastic component 22 provides a pulling force to the first magnetic component 24 in a direction opposite the stretching direction, while the second elastic component 22′ provides a pushing force to the second magnetic component 24′ in a direction (i.e., the direction B′ opposite to the first direction B) opposite to the compression direction. The first magnetic component 24 and the second magnetic component 24′ are driven to move towards the direction B′ opposite the first direction B (as shown in FIG. 7) to compress the first elastic component 22 and to stretch the second elastic component 22′. Through the extension or retraction of the first elastic component 22 and the second elastic component 22′, the first magnetic component 24 and the second magnetic component 24′ can be driven to move in the first direction B and the opposite direction B′ back and forth (as shown in FIG. 6 and FIG. 7) to make relative displacements with respect to the first metal coil 23 and the second metal coil 23′ respectively. Thereby, a first electric energy (not shown) and a second electric energy (not shown) are induced in the first metal coil 23 and the second metal coil 23′ respectively. The first electric energy and the second electric energy are rectified and voltage-regulated by the rectifier voltage regulator circuit 17 and then stored in the two electric power storage components 25 and the charging capacitor 26. Then, by connecting two terminals 28 leading from the two electric power storage components 25 to the first electrode end 211 and the second electrode end 213 of the case 21 respectively, the battery device 2 can be installed in an electronic product to generate power. In other practical implementations, the operation sequence shown in FIG. 6 and FIG. 7 may be altered. Specifically, as shown in FIG. 7, the first elastic component 22 is firstly compressed by the first magnetic component 24 to result in a compression deformation of the first elastic component 22, while the second elastic component 22′ is firstly stretched by the second magnetic component 24′ to result in a stretching deformation of the second elastic component 22′. Because the first elastic component 22 and the second elastic component 22′ have a tendency of restoring their respective original statuses, a pushing force is provided by the first elastic component 22 to the first magnetic component 24 in a direction opposite to the compression direction, while a pulling force is provided by the second elastic component 22′ to the second magnetic component 24′ in a direction opposite to the stretching direction, as shown in FIG. 6. Therefore, the operation sequence can be altered by those of ordinary skill in the art, and no further description will be made herein. Other implementations may be devised by those skilled in the art upon reviewing the description of the second embodiment. As an example, the battery device 2 shown in FIG. 8 has substantially the same components as the second embodiment; that is, the battery device 2 shown in FIG. 8 also comprises a case 21, a first elastic component 22, a second elastic component 22′, a first metal coil 23, a second metal coil 23′, a first magnetic component 24, a second magnetic component 24′, two electric power storage components 25, a rectifier and a voltage regulator circuit 27. In other words, only the charging capacitor 26 of the second embodiment is omitted, and those of ordinary skill in the art can replace it with other components with similar functions, so the present invention is not limited to what has been described above.

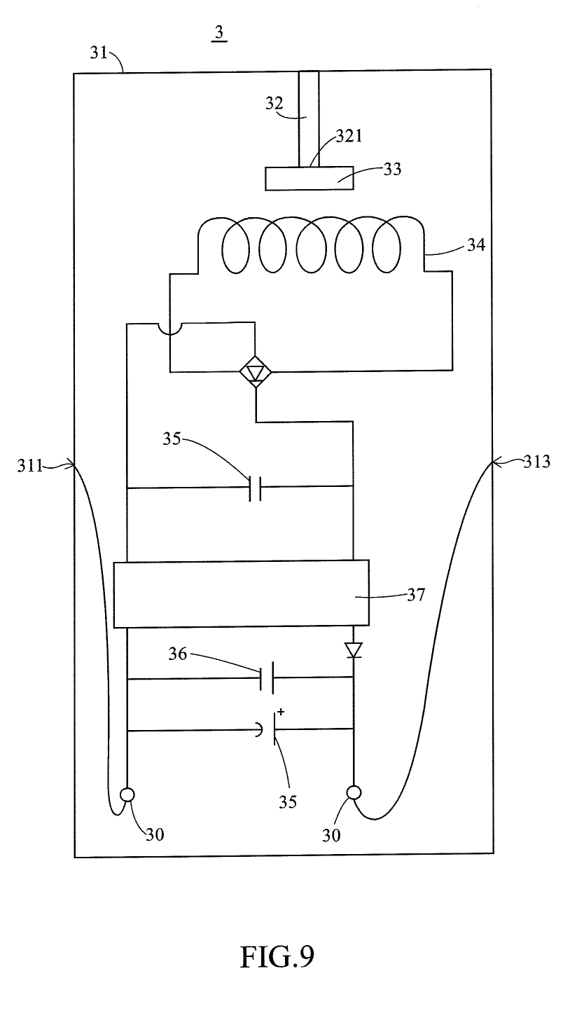

The third embodiment of the present invention is a battery device 3. FIG. 9 is a schematic view of the battery device 3 when it is not swung. The battery device 3 comprises a case 31, a first cantilever 32, a first magnetic component 33, a first metal coil 34, two electric power storage components 35, a charging capacitor 36 and a rectifier voltage regulator circuit 37.

The case 31 has a first electrode end 311 and a second electrode end 313 opposite the first electrode end 311. The first cantilever 32 is disposed in the case 31 and connected to an end of the case 31. The first magnetic component 33 is disposed at an end 321 of the first cantilever 32 that is opposite the end connected to the case 31. The first metal coil 34 is disposed in the case 31 and is parallel with the first magnetic component 33. The two electric power storage components 35 and the charging capacitor 36 are disposed in the case 31 and, respectively, connected in parallel with the first electrode end 311 and the second electrode end 313. The rectifier voltage regulator circuit 37 is electrically connected between the first metal coil 34 and the two electric power storage components 35. It shall be appreciated that in this embodiment, the battery device 3 is of a size of an AA type battery, an AAA type battery, a C type battery or a D type battery; the first cantilever 32 may be a spring or an elastic piece; the first magnetic component 33 may be a magnet; the first metal coil may be made of copper; the two electric power storage components 35 are two capacitors, and the two electric power storage components 35 are two capacitors, and the two capacitors are each gold capacitor with a small volume but a large capacity. The rectifier voltage regulator circuit 37 is an LDO (Low Drop Out) voltage regulator or a Zener diode.

Hereinbelow, the operation mechanism of the battery device 3 of this embodiment will be described in detail.

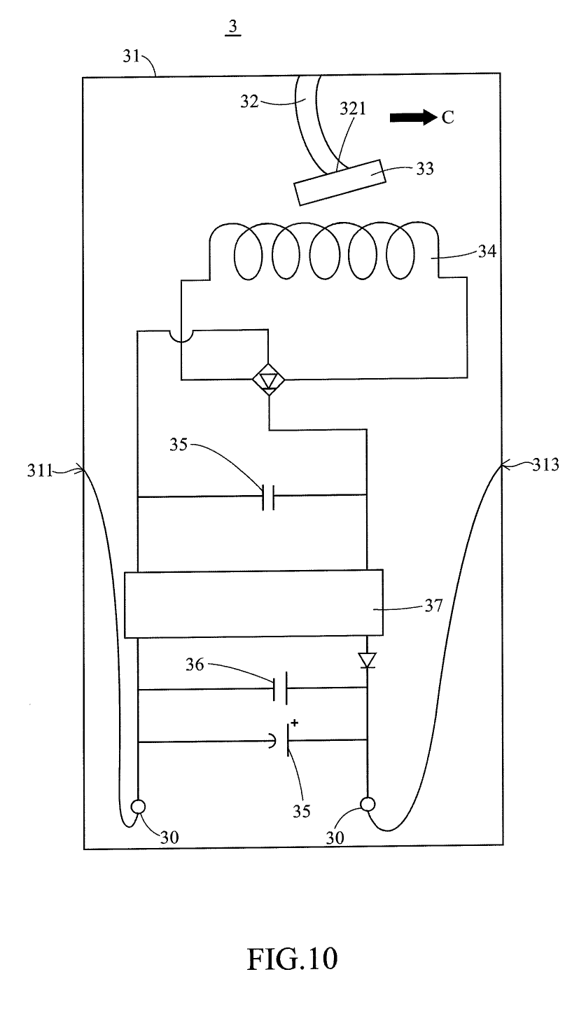

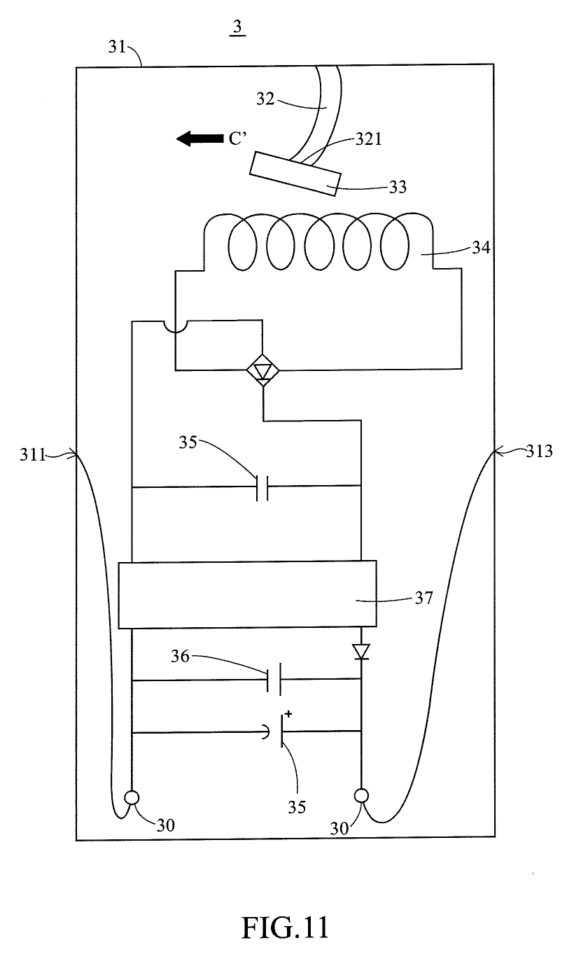

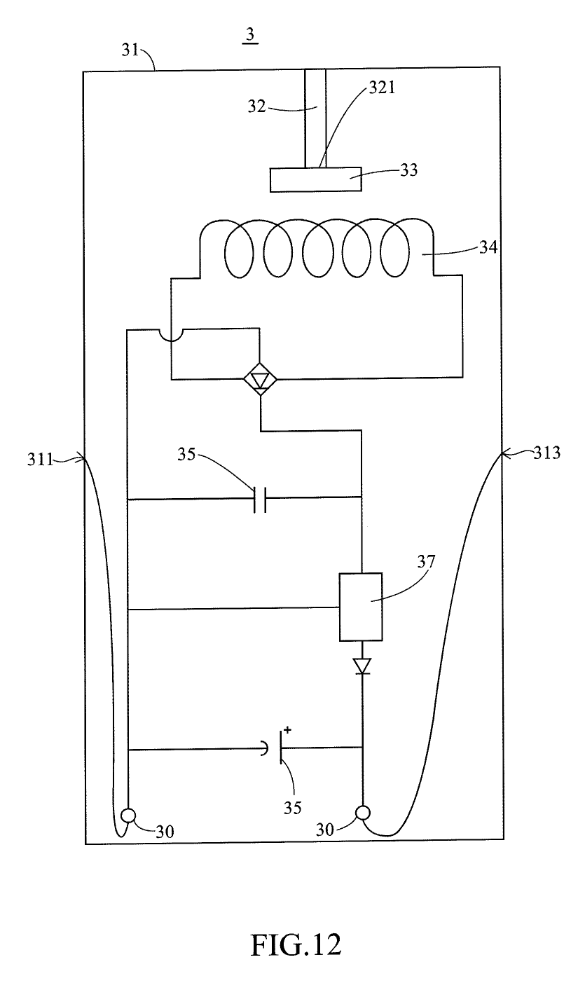

FIG. 10 illustrates a schematic view of the first cantilever 32 of the battery device 3 in a bent status. When the battery device 3 begins to move in a first direction C (as shown by the arrow) and the movement vector is greater than zero, the first cantilever 32 in the battery device 3 begins to swing along the first direction C (as shown by the arrow) from an unbent status (as shown in FIG. 9). As a result, the first cantilever 32 is bent to drive the first magnetic component 33 disposed at the end 321 of the first cantilever 32 to swing (as shown in FIG. 10), so the first cantilever 32 has a tendency to restore its original status. FIG. 11 is a schematic view of the first cantilever 32 of the battery device 3 in a status in which the elastic energy thereof is released. Then, the first cantilever 32 provides a pushing force to the first magnetic component 33 in a direction opposite to the bending direction so that the first cantilever 32 is bent again to drive the first magnetic component 33 to move towards a direction C′ opposite to the first direction C. Through the bending and swinging of the first cantilever 32, the first magnetic component 33 can be driven to move in the first direction C and the opposite direction C′ back and forth (as shown in FIG. 10 and FIG. 11) to result in relative displacements between the first magnetic component 33 and the first metal coil 34. Thereby, a first electric energy (not shown) is induced in the first metal coil 34. The first electric energy is rectified and voltage-regulated by the rectifier voltage regulator circuit 37 and then stored in the two electric power storage components 35 and the charging capacitor 36. Then, by connecting two terminals 30 leading from the two electric power storage components 35 to the first electrode end 311 and the second electrode end 313 of the case 31 respectively, the battery device 3 can be installed in an electronic product to generate power. In other practical implementations, the operation sequence shown in FIG. 10 and FIG. 11 may be altered, and no further description will be made herein. Other implementations may be devised by those skilled in the art upon reviewing the description of the third embodiment. As an example, the battery device 3 shown in FIG. 12 has substantially the same components as the third embodiment; that is, the battery device 3 shown in FIG. 12 also comprises a case 31, a first cantilever 32, a first magnetic component 33, a first metal coil 34, two electric power storage components 35 and a rectifier voltage regulator circuit 37. In other words, only the charging capacitor 36 of the third embodiment is omitted, and those of ordinary skill in the art can replace it with other components with similar functions, so the present invention is not limited to what is described above.

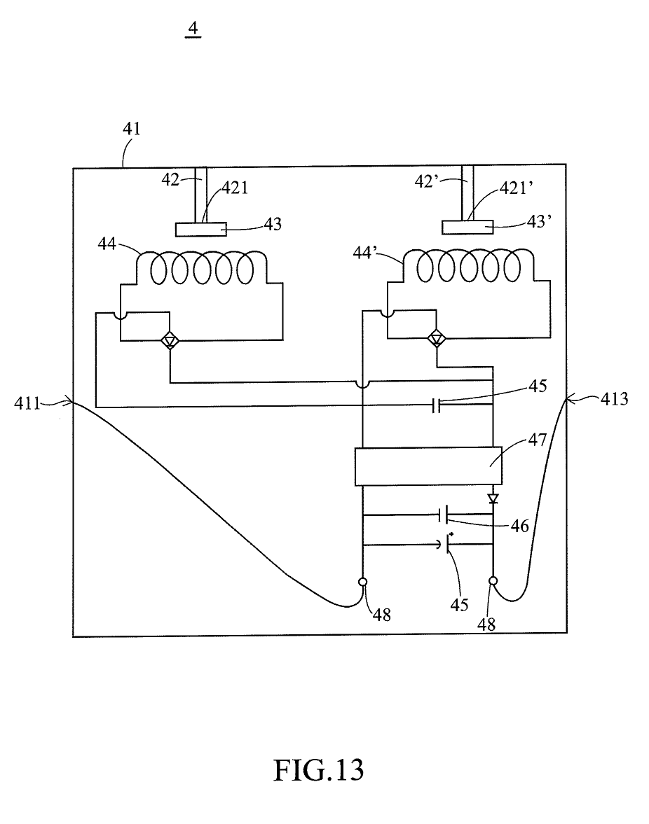

The fourth embodiment of the present invention is a battery device 4. FIG. 13 illustrates a schematic view of the battery device 4 when it is not swung. The battery device 4 of this embodiment comprises a case 41, a first cantilever 42, a second cantilever 42′, a first magnetic component 43, a second magnetic component 43′, a first metal coil 44, a second metal coil 44′, two electric power storage components 45, a charging capacitor 46 and a rectifier voltage regulator circuit 47. The first magnetic component 43 is disposed at an end 421′ of the first cantilever 42. Therefore, the components of the fourth embodiment are substantially the same as those of the third embodiment except that a second cantilever 42′, a second magnetic component 43′ and a second metal coil 44′ are additionally provided in the battery device 4. The second cantilever 42′ is disposed in the case 41 and swings synchronously with the first cantilever 42; the second magnetic component 43′ is disposed at an end 421′ of the second cantilever 42′; and the second metal coil 44′ is disposed in the case 41 and in parallel with the second magnetic component 43′. The first metal coil 44 and the second metal coil 44′ are connected in parallel.

Hereinbelow, the operation mechanism of the battery device 4 of this embodiment will be described in detail.

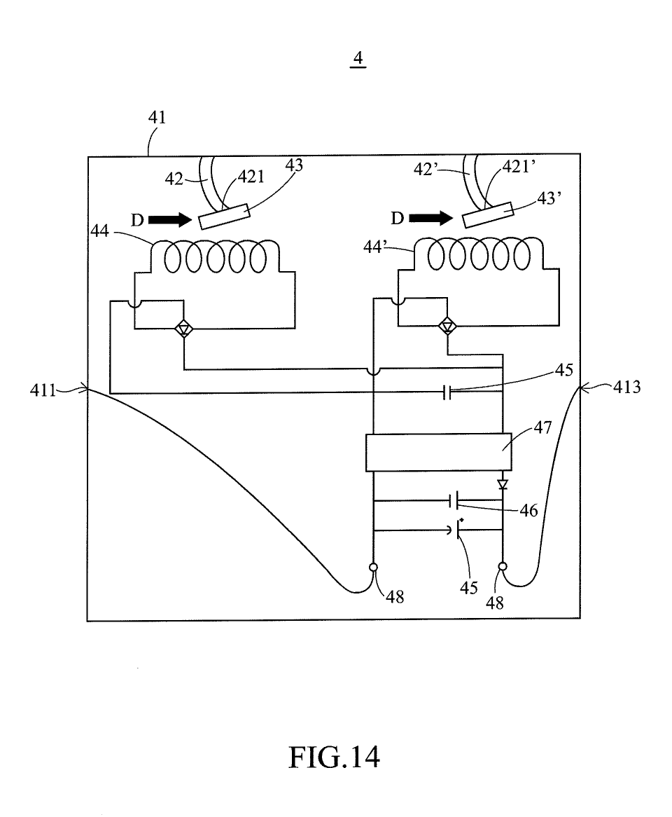

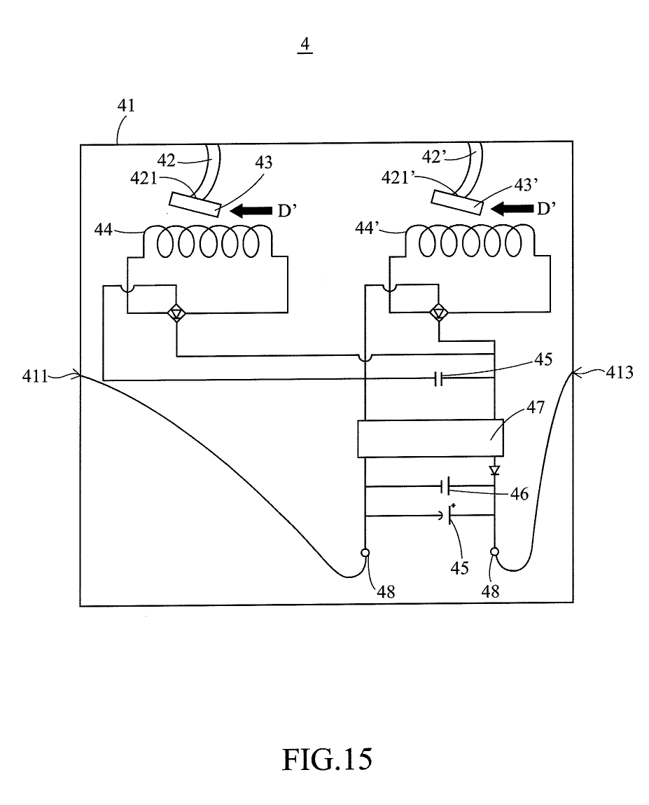

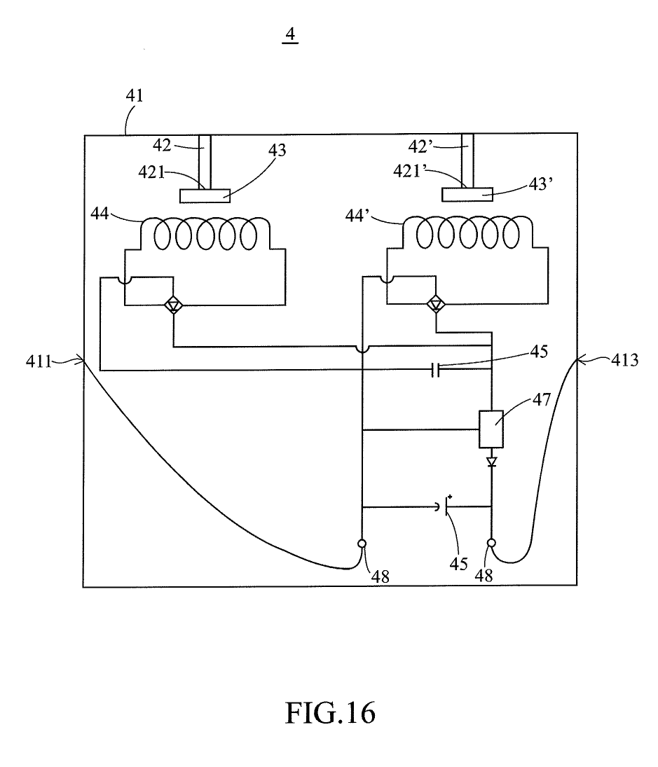

FIG. 14 illustrates a schematic view of the first cantilever 42 and the second cantilever 42′ of the battery device 4 in a bent status. When the battery device 4 begins to move in a first direction D (as shown by the arrow) and the movement vector is greater than zero, the first cantilever 42 and the second cantilever 42′ in the battery device 4 begin to swing along the first direction D (as shown by the arrow) from an unbent status (as shown in FIG. 13). As a result, the first cantilever 42 and the second cantilever 42′ are bent to drive the first magnetic component 43 and the second magnetic component 43′ disposed at the ends 421, 421′ of the first cantilever 42 and the second cantilever 42′ to swing (as shown in FIG. 14) to result in bending of the first cantilever 42 and the second cantilever 42′. The first cantilever 42 and the second cantilever 42′ have a tendency to restore their respective original statuses. FIG. 15 is a schematic view of the first cantilever 42 and the second cantilever 42′ of the battery device 4 in a status in which the elastic energy thereof is released. Then, the first cantilever 42 and the second cantilever 42′ provide a pushing force to the first magnetic component 43 and the second magnetic component 43 respectively in a direction opposite to the bending direction so that the first cantilever 42 and the second cantilever 42′ are bent again to drive the first magnetic component 43 and the second magnetic component 43′ to move towards a direction D′ opposite to the first direction D. Through the bending and swinging of the first cantilever 42 and the second cantilever 42′, the first magnetic component 43 and the second magnetic component 43′ can be driven to move in the first direction D and the opposite direction D′ back and forth (as shown in FIG. 14 and FIG. 15) to result in relative displacements between the first and the second magnetic component 43, 43′ and the first and the second metal coil 44, 44′. Thereby, a first electric energy (not shown) is induced in the first metal coil 44, while a second electric energy (not shown) is induced in the second metal coil 44′. The first electric energy and the second electric energy are rectified and voltage-regulated by the rectifier voltage regulator circuit 47 and then stored in the two electric power storage components 45 and the charging capacitor 46. Then, by connecting two terminals 48 leading from the two electric power storage components 45 to the first electrode end 411 and the second electrode end 413 of the case 41 respectively, the battery device 4 can be installed in an electronic product to generate power. In other practical implementations, the operation sequence shown in FIG. 14 and FIG. 15 may be altered by those of ordinary skill in the art, and no further description will be made herein. Other implementations may be devised by those skilled in the art upon reviewing the description of the fourth embodiment. As an example, the battery device 4 shown in FIG. 16 has substantially the same components as the fourth embodiment; that is, the battery device 4 shown in FIG. 16 also comprises a case 41, a first cantilever 42, a second cantilever 42′, a first magnetic component 43, a second magnetic component 43′, a first metal coil 44, a second metal coil 44′, two electric power storage components 45 and a rectifier voltage regulator circuit 47. In other words, only the charging capacitor 46 is omitted in the fourth embodiment, and those of ordinary skill in the art can replace it with other components with similar functions, so the present invention is not limited to what has been described above.

The aforesaid embodiments all relate to a battery device capable of generating electric power by itself and supplying electric power to a load. The manner in which the battery device operates is not limited to generating electric power only through swinging in a left-and-right direction; instead, electric power can be generated through movement in any of a vertical direction, a left-and-right direction and a front-and-back direction. Therefore, when the battery device is used in an electronic product, electric power can be generated and stored as long as the electronic product (e.g., a mouse or a remote controller) moves naturally. Furthermore, the number of capacitors/charging capacitors may be decreased or increased optionally depending on the power consumption level to satisfy the different needs of users for power consumption.

According to the above descriptions, the battery device of the present invention can not only generate power consistently but also allow for repeated use, so the subsequent harm to the environment can be avoided. Therefore, the battery device of the present invention features simple operations and is less harmful to the environment, and meanwhile, can generate power by itself without the need of discarding the battery device after a time period of use.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A battery device, comprising:
a case, having a first electrode end and a second electrode end opposite to the first electrode end;
a first elastic component, being disposed in the case, and extending or retracting along a first direction;
a first metal coil, being disposed in the case, and defining a first receiving space;
a first magnetic component, being disposed in the first receiving space and connecting to an end of the first elastic component;
at least one electric power storage component, being disposed in the case, and being connected in parallel with the first electrode end and the second electrode end; and
a rectifier voltage regulator circuit, being electrically connected between the first metal coil and the at least one electric power storage component,
wherein when the battery device moves along the first direction back and forth, the first elastic component extends or retracts to drive the first magnetic component to move back and forth along the first direction to make a relative displacement with respect to the first metal coil, and thereby, the first metal coil generates a first electrical energy, which is rectified and voltage-regulated by the rectifier voltage regulator circuit and then stored in the at least one electric power storage component.

2. The battery device as claimed in claim 1, wherein the at least one electric power storage component comprises two capacitors connected in parallel with the first electrode end and the second electrode end.

3. The battery device as claimed in claim 1, further comprising a second elastic component, being disposed in the case and extending or retracting along the first direction.

4. The battery device as claimed in claim 3, further comprising a second metal coil, being disposed in the case and defining a second receiving space.

5. The battery device as claimed in claim 4, further comprising a second magnetic component, being disposed in the second receiving space and connecting to an end of the second elastic component.

6. The battery device as claimed in claim 5, wherein the first metal coil and the second metal coil are connected in parallel.

7. The battery device as claimed in claim 6, wherein when the battery device moves along the first direction back and forth, the second elastic component extends or retracts to drive the second magnetic component to move back and forth along the first direction to make a relative displacement with respect to the second metal coil, and thereby, the second metal coil generates a second electrical energy, which is rectified and voltage-regulated by the rectifier voltage regulator circuit and then stored in the at least one electric power storage component.

8. The battery device as claimed in claim 7, wherein the first elastic component and the second elastic component are springs or elastic pieces.

9. The battery device as claimed in claim 7, wherein the first magnetic component and the second magnetic component are magnets.

10. The battery device as claimed in claim 7, wherein a material of the first metal coil and the second metal coil is copper.

11. The battery device as claimed in claim 1, wherein the battery device is of a size of an AA type battery, an AAA type battery, a C type battery or a D type battery.

12. The battery device as claimed in claim 2, wherein the capacitors are gold capacitors.

13. The battery device as claimed in claim 1, wherein the rectifier voltage regulator circuit is a LDO (Low Drop Out) voltage regulator or a Zener Diode.

14. A battery device, comprising:
a case, having a first electrode end and a second electrode end opposite to the first electrode end;
a first cantilever, being disposed in the case;
a first magnetic component, being disposed at an end of the first cantilever;
a first metal coil, being disposed in the case and parallel to the first magnetic component;
at least one electric power storage component, being disposed in the case, and connected in parallel with the first electrode end and the second electrode end; and
a rectifier voltage regulator circuit, being electrically connected between the first metal coil and the at least one electric power storage component,
wherein the first cantilever drives the first magnetic component disposed at the end to make a relative displacement with respect to the first metal coil when the battery device moves, and thereby, the first metal coil generates a first electrical energy, which is rectified and voltage-regulated by the rectifier voltage regulator circuit and then stored in the at least one electric power storage component.

15. The battery device as claimed in claim 14, wherein the at least one electric power storage component comprises two capacitors connected in parallel with the first electrode end and the second electrode end.

16. The battery device as claimed in claim 14, further comprising a second cantilever, being disposed in the case.

17. The battery device as claimed in claim 16, further comprising a second magnetic component, being disposed at an end of the second cantilever.

18. The battery device as claimed in claim 17, further comprising a second metal coil, being disposed in the case and being parallel with the second magnetic component.

19. The battery device as claimed in claim 18, wherein the second cantilever drives the second magnetic component disposed at the end to make a relative displacement with respect to the second metal coil when the battery device moves, and thereby, the second metal coil generates a second electrical energy, which is rectified and voltage-regulated by the rectifier voltage regulator circuit and then stored in the at least one electric power storage component.

20. The battery device as claimed in claim 19, wherein the first metal coil and the second metal coil are connected in parallel.

21. The battery device as claimed in claim 19, wherein the first cantilever and the second cantilever are springs or elastic pieces.

22. The battery device as claimed in claim 19, wherein the first magnetic component and the second magnetic component are magnets.

23. The battery device as claimed in claim 19, wherein a material of the first metal coil and the second metal moil is copper.

24. The battery device as claimed in claim 14, wherein the battery device is of a size of an AA type battery, an AAA type battery, a C type battery or a D type battery.

25. The battery device as claimed in claim 15, wherein the capacitors are gold capacitors.

26. The battery device as claimed in claim 14, wherein the rectifier voltage regulator circuit is a LDO (Low Drop Out) voltage regulator or a Zener Diode.
